(19) United States
(12) Patent Application Publication
(10) Pub. No.: US 2025/0389148 A1
(43) Pub. Date: Dec. 25, 2025

(54) Vision Panel

(71) Applicant: Focus DGI Limited, Welham Green (GB)

(72) Inventor: David Graham Davis, Welham Green (GB)

(73) Assignee: Focus DGI Limited, Welham Green (GB)

(21) Appl. No.: 19/307,736

(22) Filed: Aug. 22, 2025

Related U.S. Application Data
(63) Continuation of application No. PCT/GB2024/050478, filed on Feb. 21, 2024.

(30) Foreign Application Priority Data
Feb. 23, 2023 (GB) 2302609.9
Oct. 24, 2023 (GB) 2316236.5

(51) Int. Cl. E06B 3/58; E06B 3/56; E06B 3/66

(52) U.S. Cl. CPC E06B 3/5892; E06B 3/56; E06B 3/6617

(57) ABSTRACT

According to the present disclosure, there is provided vision panel assembly for use in a fire door, comprising first and second window panels having a fire-rated vision panel sandwiched therebetween. Also provided is a door leaf for use in a fire door and a fire door comprising a vision panel assembly and a door leaf. A method of assembling a vision panel assemble, a door leaf and a fire door are also provided.

### BACKGROUND

This invention relates to fire doors, and more specifically to vision panels for insertion into fire doors.

Fire doors are doors that are resistant to fire. Typically, a fire door will have a particular fire-resistance rating, which indicates the amount of time that the door has been tested to withstand during a fire resistance test. The fire resistance rating, which may also be referred to as “fire rating”, indicates the amount of time for which door is rated to withstand a fire at a given temperature. Typically, the hotter the fire the less time a fire door will be able to provide resistance. The fire rating of a door will therefore typically be measured and reported by way of a time vs temperature chart, indicating the time for which the fire door is able to resist a fire at a given temperature. Alternatively, a fire rating may only mention a time, referring to the time for which the fire door is able to resist a fire under typical conditions.

Fire doors are typically used as part of a passive fire system, in order to reduce the spread of fire and smoke in the event of a fire within a building. While it is important for a fire door to provide adequate fire resistance, it is often also desirable for a fire door to incorporate a window (or “vision panel”) to allow a person to see through to the other side a fire door when it is closed. A typical fire door comprises a “door leaf”, which is the main body of the door, and a “vision panel” which is a window of transparent material disposed within the door leaf. This may be advantageous, for example, during a fire to allow a person to more easily check whether the other side of the door is safe.

The vision panel of a fire door may incorporate one or more windows, however at least one of the windows must be fire-rated in order for the door to retain its fire rating. As part of the fire rating test, the vision panel must be retained within the door leaf during testing and must resist the fire in combination with the door leaf.

Constructing a door comprising a fire-rated vision panel can be challenging, as the fire-rated vision panel must be installed in such a way that it is successfully retained within the door leaf in the event of a fire, in order to provide fire resistance.

### SUMMARY OF INVENTION

According to a first aspect of the invention, there is provided a door leaf, for use in a fire door, comprising a leaf body having first and second opposed sides and a vision panel assembly receiving aperture extending therethrough, the receiving aperture having a stepped formation defining a second abutment surface co-operable in use with a complementary first abutment surface of a vision panel assembly to position the vision panel assembly within the door leaf.

This is advantageous as the cooperation between the first abutment surface of a vision panel assembly and the second abutment surface of the door leaf allow for the vision panel assembly to be quickly, easily and accurately installed within the door leaf in order to produce a fire door comprising a vision panel.

In an embodiment, the receiving aperture extends all the way through the leaf body of the door leaf. This is advantageous as it allows for the vision panel to be installed in the aperture and to thereby allow viewing through the door leaf while maintaining the fire resistance of the fire door.

In an embodiment, the stepped formation extends around the whole of the receiving aperture. This is advantageous as it can allow for the first abutment surface of a vision panel assembly to be in cooperative contact with the stepped formation that forms the second abutment surface around the whole perimeter of the vision panel assembly, further improving the ease with which the vision panel can be installed and retained within the receiving aperture.

In an embodiment, the door leaf further comprises at least one retention formation located within the receiving aperture between the stepped formation and the first side of the leaf body. This is advantageous as the retention formation can allow for a retention member to be more easily positioned and retained within the receiving aperture.

In an embodiment, the door leaf further comprises a groove to, in use, receive an intumescent strip. This is advantageous as the groove can allow for an intumescent strip to be more easily positioned and retained within the receiving aperture.

Optionally, the groove is located within the receiving aperture between the stepped formation and the first side of the leaf body. This is advantageous as it allows for the intumescent strip to be received and positioned between a vision panel of a vision panel assembly, and the first side of the leaf body.

In an embodiment of a door leaf including at least one retention formation, the groove is located within the receiving aperture between the retention formation and the stepped formation. This is advantageous because, in use, it allows for the intumescent strip and the at least one retention member help to retain the fire-rated panel within the door leaf of the fire door.

According to a second aspect of the invention, there is provided vision panel assembly, for use in a fire door, comprising first and second window panels having a fire-rated vision panel sandwiched therebetween, the first and second window panels being spaced from the vision panel, and the vision panel having a larger cross-sectional area than the second window panel whereby an outer perimeter of the vision panel extends beyond the second window panel to define a first abutment surface co-operable in use with a complementary second abutment surface of a door leaf to position the vision panel assembly within the door leaf.

This is advantageous as the cooperation between the first abutment surface of the vision panel assembly and the second abutment surface of a door leaf allow for the vision panel assembly to be quickly and easily, as well as accurately, installed within the door leaf in order to produce a fire door comprising a vision panel. Thus, the invention avoids difficult and time-consuming fabrication methods that typically are otherwise needed in order to construct a fire rated door comprising a vision panel.

The inclusion of a first and second window panel, while allowing for the fire-rated vision panel to be located accurately within the door leaf, provide an additional window panel located on either side of the door. This may, for example, prevent damage to the fire-rated vision panel when the fire door is in non-fire related use. The spacing between the first and second window panels and the fire-rated vision panel may also improve the thermal insulation provided by the door in non-fire related usage, by providing insulating air gaps between the sides of the fire door.

In an embodiment, the first window panel is spaced from the vision panel by at least one first spacer. This is advantageous as it may allow for the separation between the first window panel and the vision panel to be more easily established and maintained. The first spacer may be in contact with each of the first window panel and the vision panel, thereby to provide better structural support to the vision panel assembly.

In an embodiment, the second window panel is spaced from the vision panel by at least one second spacer. This is advantageous as it may allow for the separation between the second window panel and the vision panel to be more easily established and maintained. The second spacer may be in contact with each of the second window panel and the vision panel, thereby to provide better structural support to the vision panel assembly.

In an embodiment, the whole outer perimeter of the vision panel extends beyond the second window panel. This is advantageous as it can allow for the first abutment surface to be in cooperative contact with the second abutment surface around the whole perimeter of the vision panel assembly, further improving the ease with which the vision panel can be installed and retained within a fire door, as well as the accuracy with which the vision panel is positioned within the fire door.

In an embodiment, the vision panel defines a second abutment surface arranged opposite to the first abutment surface. This is advantageous as, in use, it provides an abutment surface that can be used to help retain the fire-rated vision panel within the door leaf.

In a third aspect, there is provided a fire door comprising a vision panel assembly according to a first aspect and a door leaf according to a second aspect, the vision panel assembly being received within the receiving aperture of the door leaf and the first abutment surface of the vision panel assembly cooperating with the complementary second abutment surface of the door leaf to position the vision panel assembly within the door leaf.

This is advantageous as the cooperation between the first abutment surface of the vision panel and the second abutment surface of the door leaf allow for the vision panel assembly to be quickly, easily and accurately installed within the door leaf in order to produce a fire door comprising a vision panel.

In an embodiment, when the first abutment surface of the vision panel assembly is cooperating with the complementary second abutment surface of the door leaf, the vision panel is located on the first side of the stepped formation. This is advantageous as the vision panel assembly can be inserted into the door leaf from the first side of the door leaf.

In an embodiment, the door leaf includes a groove to, in use, receive an intumescent strip. This is advantageous as the groove can allow for an intumescent strip to be more easily positioned and retained within the door leaf.

Optionally, the groove is located within the receiving aperture between the stepped formation and the first side of the leaf body. This is advantageous as it allows for the intumescent strip to be received and positioned between the vision panel of the vision panel assembly, and the first side of the leaf body.

Optionally, an intumescent strip is located within the groove. This is advantageous because, when exposed to a fire, the intumescent strip can act to at least partially retain the vision panel within the receiving aperture.

Optionally, when the first abutment surface of the vision panel assembly is cooperating with the complementary second abutment surface of the door leaf, the intumescent strip is at least partially located between the vision panel and the groove. This is advantageous because when the intumescent strip is exposed to a fire, it expands and thereby exerts a force at least partially between the edge of the vision panel and the groove, thereby helping to retain the vision panel within the receiving aperture.

Optionally, when the first abutment surface of the vision panel assembly is cooperating with the complementary second abutment surface of the door leaf, the intumescent strip is located at least partially on the side of the vision panel opposite to the first abutment surface. This is advantageous because when the intumescent strip is exposed to a fire, it expands and thereby provides a physical barrier between the vision panel and the first side of the door. This helps to retain the vision panel within the fire door.

In an embodiment, the fire door further comprises an adhesive located between the first and second abutment surfaces, preferably fire rated silicone. This is advantageous as it may assist with retaining the vision panel within the receiving aperture during construction and during non-fire related use. This may also be advantageous in helping to retain the vision panel within the receiving aperture when the fire door is exposed to a fire.

In an embodiment, after the vision panel is received within the receiving aperture of the door leaf, the outer surface of the first window panel is substantially flush with the first side of the leaf body. This is advantageous as it may improve the ease with which the first side of the fire door can be cleaned and maintained. This can be particularly advantageous in applications where cleanliness is of particular importance, for example in a hospital environment.

In an embodiment, after the vision panel is received within the receiving aperture of the door leaf, the outer surface of the second window panel is substantially flush with the second side of the leaf body. This is advantageous as it may improve the ease with which the second side of the fire door can be cleaned and maintained. This can be particularly advantageous in applications where cleanliness is of particular importance, for example in a hospital environment.

In an embodiment including at least one retention formation, the or each retention formation frictionally retains a corresponding retention member, against which the second abutment surface of the vision panel is abuttable. This is advantageous as, in use, the at least one frictionally retained retention member helps retain the fire-rated panel within the door leaf of the fire door.

In an embodiment including an intumescent strip, in use, the intumescent strip is expandable between at least one retention member and the vision panel. This is advantageous because, in use, the intumescent strip and the at least one retention member help to retain the fire-rated panel within the door leaf of the fire door.

In an embodiment, the (or each) retention member comprises a fire-resistant material. This is advantageous as the fire-resistant material will allow the retention member to continue to help retain the fire rated panel within the door, even when exposed to a fire. Preferably, the fire-resistant material is calcium silicate. Calcium silicate is advantageous because it is fire-resistant and offers good structural properties for use in retaining the fire-rated panel within the door leaf.

According to a fourth aspect, there is provided a method of assembling a vision panel assembly for use in a fire door, the vision panel assembly comprising first and second window panels and a fire-rated vision panel with a larger cross-sectional area than the second window panel, the method comprising the steps of:
(a) sandwiching the fire-rated vision panel between first and second window panels while spacing the first and second window panels from the vision panel; and
(b) arranging the vision panel relative to the second window panel so that an outer perimeter of the vision panel extends beyond the second window panel to define a first abutment surface co-operable in use with a complementary second abutment surface of a door leaf to position the vision panel assembly within the door leaf.

This is advantageous as the cooperation between the first abutment surface of the vision panel assembly and the second abutment surface of a door leaf allow for the vision panel assembly to be quickly, easily and accurately installed within the door leaf in order to produce a fire door comprising a vision panel.

In an embodiment, the method further comprises a step of inserting at least one first spacer between the first window panel and the vision panel. This is advantageous as it may allow for the separation between the first window panel and the vision panel to be more easily established and maintained. The first spacer may by in contact with each of the first window panel and the vision panel, thereby to provide better structural support to the vision panel assembly.

Optionally, each of the at least one first spacers are located substantially adjacent to an edge of the first window panel. This is advantageous as it allows for the first spacer(s) and the edge of the first window panel to be formed substantially without a gap or separation, which may allow for the vision panel assembly to be more easily inserted into the receiving aperture of a door leaf.

In an embodiment, the method further comprises a step of inserting at least one second spacer between the second window panel and the vision panel. This is advantageous as it may allow for the separation between the first window panel and the vision panel to be more easily established and maintained. The first spacer may by in contact with each of the first window panel and the vision panel, thereby to provide better structural support to the vision panel assembly.

Optionally, each of the at least one second spacers are located substantially adjacent to an edge of the second window panel. This is advantageous as it allows for the second spacer(s) and the edge of the second window panel to be formed substantially without a gap or separation, which may allow for the vision panel assembly to be more easily inserted into the receiving aperture of a door leaf.

According to a fifth aspect, there is provided a method of forming a door leaf for use in a fire door, the door leaf comprising a leaf body having first and second opposed sides, the method comprising the steps of:
(a) creating a receiving aperture which extends through the door leaf; and
(b) forming within the receiving aperture a stepped formation that defines a second abutment surface co-operable in use with a complementary first abutment surface of a vision panel assembly to position the vision panel assembly within the door leaf.

This is advantageous as the cooperation between the first abutment surface of a vision panel assembly and the second abutment surface of the door leaf allow for the vision panel assembly to be quickly, easily and accurately installed within the door leaf in order to produce a fire door comprising a vision panel.

In an embodiment, the method further comprises a step of forming a groove within the receiving aperture. This is advantageous as the groove can allow for an intumescent strip to be more easily positioned and retained within the door leaf.

In an embodiment, the method further comprises a step of forming a retention formation within the receiving aperture. This is advantageous as the retention formation can allow for a retention member to be more easily positioned and retained within the receiving aperture.

In a sixth aspect, there is provided a method of assembling a fire door comprising a door leaf formed according to a fifth aspect and a vision panel assembly assembled according to a fourth aspect, the method comprising the step of inserting the vision panel assembly into the receiving aperture of the door leaf such that the first abutment surface of the vision panel assembly cooperates with the complimentary second abutment surface of the receiving aperture to position the vision panel assembly with the door leaf.

This is advantageous as the cooperation between the first abutment surface of the vision panel and the second abutment surface of the door leaf allow for the vision panel assembly to be quickly, easily and accurately installed within the door leaf in order to produce a fire door comprising a vision panel.

In an embodiment, the method further comprising a step of inserting into a retention formation a corresponding retention member, prior to the insertion of the vision panel assembly into the receiving aperture of the door leaf. This is advantageous as it can allow for a retention member to be introduced to the door leaf without needing modifications to the vision panel assembly. This is further advantageous because it can avoid any need to substantially modify the method for inserting the vision panel into the door leaf.

In an embodiment, the method further comprises a step of applying an adhesive to at least one of the first abutment surface and the second abutment surface, before the vision panel assembly is inserted into the receiving aperture. This is advantageous as it may assist with retaining the vision panel within the receiving aperture during construction and during non-fire related use. This may also be advantageous in helping to retain the vision panel within the receiving aperture when the fire door is exposed to a fire.

Within the scope of this application, it is expressly intended that the various aspects, embodiments, examples and alternatives set out in the preceding paragraphs, and the claims and/or the following description and drawings, and in particular the individual features thereof, may be taken independently or in any combination, That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present disclosure will now be described by way of example only, with reference to the accompanying drawings, in which:

FIG. 1 shows a vision panel assembly according to the present disclosure;

FIG. 2 shows a door leaf according to the present disclosure;

FIG. 3 shows a receiving aperture in a door leaf according to the present disclosure;

FIG. 4 shows a receiving aperture in a door leaf with an intumescent strip and an adhesive according to the present disclosure;

FIG. 5 shows a fire door comprising a door leaf and a vision panel assembly according to the present disclosure;

FIG. 6 shows a fire door comprising a door leaf including a retention member, and a vision panel assembly, according to the present disclosure;

FIG. 7 shows a door leaf with a retention formation and a retention member according to the present disclosure;

FIG. 8 shows a door leaf with a retention member according to the present disclosure; and

FIG. 9 shows a vision panel being inserted into a door leaf, the door leaf including a retention member, according to the present disclosure.

### DETAILED DESCRIPTION

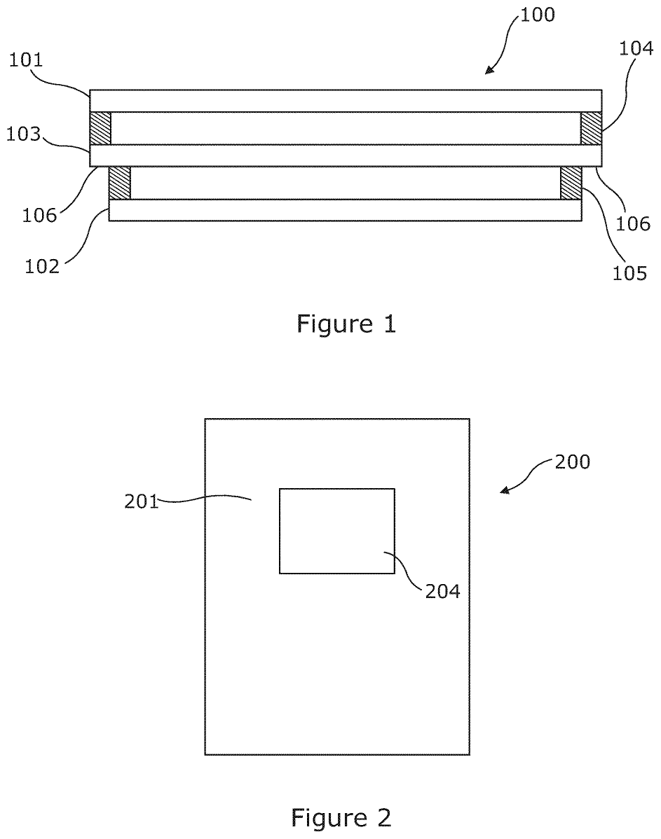

FIG. 1 illustrates an example of a vision panel assembly 100 according to the present invention. The vision panel assembly 100 comprises a first window panel 101 and a second window panel 102. A vision panel 103 is sandwiched between the first window panel 101 and the second window panel 102. The vision panel 103 is fire-rated, which means that it is rated to withstanding a fire at a particular temperature for a particular amount of time, without losing structural integrity.

Each of the first window panel 101, second window panel 102 and the vision panel 103 are substantially transparent, such that it is possible to see through the vision panel assembly 100. In some examples, the first window panel 101 and/or the second window panel 102 may comprise a material selected from a group consisting of: glass and plastic. Each of these materials provide adequate structural and optical properties. In some examples, the first window panel 101 and/or the second window panel 102 may also be fire-rated. In some examples, the first window panel 101 and/or the second window panel 102 are not fire rated.

In some examples, the vision panel 103 comprises a fire-rated glass, each of these materials provide adequate structural and optical properties and exhibit sufficient fire resistance to satisfy the fire-rating requirements. In some examples, the vision panel 103 has a fire rating of at least 30 minutes.

In some examples, at least one of the first window panel 101, the second window panel 102 and the vision panel 103 may comprise a lead-containing glass configured to provide radiation shielding. The lead-containing glass may be advantageous in preventing, or at least limiting, the transmission of radiation (for example, x-ray radiation) through the vision panel assembly 100.

In the illustrated example, the first window panel 101 and the vision panel 103 have substantially the same cross-sectional shape and area. This can be advantageous as it allows for the vision panel assembly 100 to be fitted more easily into the receiving aperture 204 of a door leaf 200. In some examples, the first window panel 101 may have a different cross-sectional area and/or shape to the vision panel 103.

At least part of the outer perimeter of the vision panel 103 extends beyond the second window panel 102. The portion of the outer perimeter of the vision panel 103 that extends beyond the second window panel 102 defines a first abutment surface 106. In some examples, the entire outer perimeter of the vision panel 103 extends beyond the second window panel 102.

In some examples, the vision panel assembly 100 further comprises at least one first spacer 104. In the illustrated example, the first spacer 104 is located between the first window panel 101 and the vision panel 103 and is in contact with each. In the illustrated example, the first spacer 104 is located substantially at the edge of each of the first window panel 101 and the vision panel 103. This can be advantageous as it allows for the vision panel assembly 100 to be fitted more easily into the receiving aperture 204 of a door leaf 200.

In some examples, more than one first spacer 104 may be located between the first window panel 101 and the vision panel 103. In some examples, a first spacer 104 may be used with a shape substantially similar to that of the outer perimeter of the first window panel 101 and/or the vision panel 103. In such examples, the first spacer 104 may comprise a single continuous piece or may be constructed from multiple pieces joined together. In an example, a separate straight piece of first spacer material corresponding to each edge of the first window panel 101 (or the vision panel 103) may be joined together to form a shape corresponding to the outer perimeter of the first window panel 101 (or the vision panel 103). In such an example, the first spacer pieces may be joined by one or more joining members (not shown) or an adhesive. In another example, the first spacer pieces may comprise joining portions that can be joined to further first spacer pieces to form a first spacer 104, without (or in addition to) additional joining members and/or adhesive.

In some examples, the vision panel assembly 100 further comprises at least one second spacer 105. In the illustrated example, the second spacer 105 is located between the second window panel 102 and the vision panel 103 and is in contact with each. In the illustrated example, the second spacer 105 is located substantially at the edge of the second window panel 102. This can be advantageous as it allows for the vision panel assembly 100 to be fitted more easily into the receiving aperture 204 of a door leaf 200.

In some examples, more than one second spacer 105 may be located between the second window panel 102 and the vision panel 103. In some examples, a second spacer 105 may be used with a shape substantially similar to that of the outer perimeter of the second window panel 102 and/or the vision panel 103. In such examples, the second spacer 105 may comprise a single continuous piece or may be constructed from multiple pieces joined together. In an example, a separate straight piece of second spacer material corresponding to each edge of the second window panel 102 (or the vision panel 103) may be joined together to form a shape corresponding to the outer perimeter of the second window panel 102 (or the vision panel 103). In such an example, the second spacer pieces may be joined by one or more joining members (not shown) or an adhesive. In another example, the second spacer pieces may comprise joining portions that can be joined to further second spacer pieces to form a second spacer 105, without (or in addition to) additional joining members and/or adhesive.

In some examples, a bonding material (such as an adhesive) may be applied to the outer side of the join between the spacers (104, 105) and the window/vision panels (101, 102, 103). This can be advantageous in providing further strength and stability to the vision panel assembly 100. This can also be advantageous in providing a smooth outer surface to the vision panel assembly 100 in order to more easily facilitate the insertion of the vision panel assembly 100 into a receiving aperture 204 of a door leaf 200.

In some examples, the spacers (104, 105) may be bonded to the window panels (102, 102) and/or the vision panel 103. In such examples, an adhesive such as double-sided tape may be used. This may be advantageous in providing structural support to the vision panel assembly 100.

FIG. 2 illustrates an example of a door leaf 200 according to the present disclosure. The door leaf 200 comprises a leaf body 201 and a receiving aperture 204. In some examples, the receiving aperture 204 may be located away from any of the edges of the leaf body 201. This may be advantageous in improving the structural strength and integrity of the leaf body 201.

In some examples, the leaf body 201 of the door leaf 200 may comprise a material selected from a group consisting of: chipboard or laminated timber. Each of these materials provide adequate structural strength and durability, while also providing adequate fire resistance. In some examples, the door leaf 201 has a fire rating of at least 30 minutes.

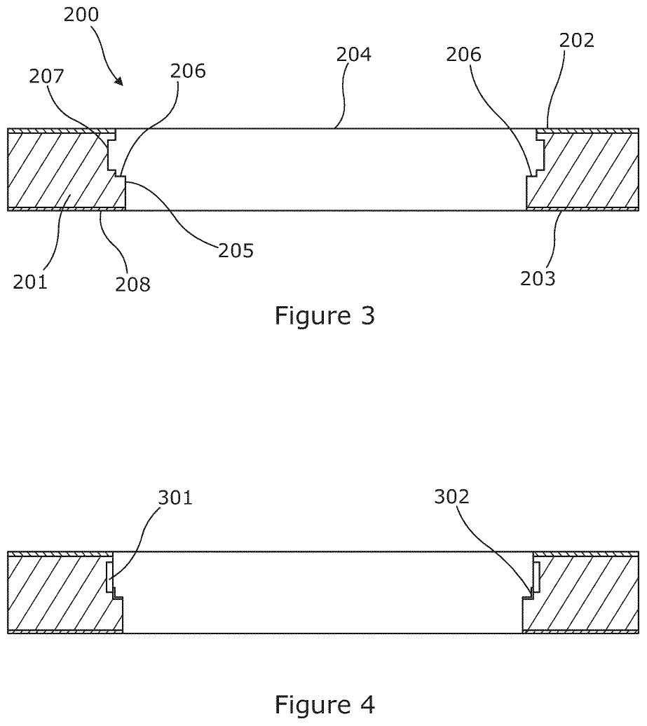

FIG. 3 illustrates a further example of a door leaf 200 according to the present disclosure. The door leaf 200 comprises a leaf body 201 and a receiving aperture 204. The receiving aperture extends from a first side 202 of the leaf body 201 to a second side 203 of the leaf body 201. The receiving aperture 204 comprises a stepped formation 205. The stepped formation 205 defines a second abutment surface 206.

In some examples, the leaf body 201 may be, at least partially, coated on a first side 202 and/or a second side 203 with an outer coating 208. The outer coating 208 may be selected from a group of materials consisting of: polyvinyl chloride (PVC), high pressure laminate, timber veneer or paint. Each of these materials may provide the leaf body with improved structural, fire resistance, hygiene, cleaning and/or aesthetic properties.

In some examples, the leaf body 201 may further comprise a lead-containing layer configured to provide radiation shielding disposed on a first side 202 and/or a second side 203 of the leaf body 201. In examples where the leaf body 201 is at least partially coated with an outer coating 208, the lead-containing layer may be disposed between the leaf body 201 and the outer coating 208 such that the outer coating 208 at least partially covers the lead-containing layer. The lead-containing layer may be advantageous in preventing, or at least limiting, the transmission of radiation (for example, x-ray radiation) through the fire door 300.

In some examples, the receiving aperture 204 further comprises a groove 207 suitable for receiving an intumescent strip 301. In some examples, the groove 207 is located between the stepped formation 205 and the first side 202 of the leaf body 201.

FIG. 4 illustrates a receiving aperture 204 in a leaf body 201 comprising a stepped formation 205 and a groove 207. An intumescent strip 301 is located within the groove 207. In the illustrated example, an adhesive 302 has been applied to the second abutment surface 206 of the stepped formation 205. In the illustrated example, the adhesive 302 has also been applied to a portion of the wall of the receiving aperture 204 between the stepped formation 205 and the groove 207.

An intumescent strip 301 is a strip of material that expands when exposed to heat. Intumescent strips are well known features of fire doors, and may be used to help seal a fire door in place when exposed to a fire, or may be used to strengthen aspects of the fire resistance of a door. The intumescent strip 301 may comprise any suitable intumescent material, for example a graphite-based material, a sodium silicate-based material or an ammonium phosphate-based material.

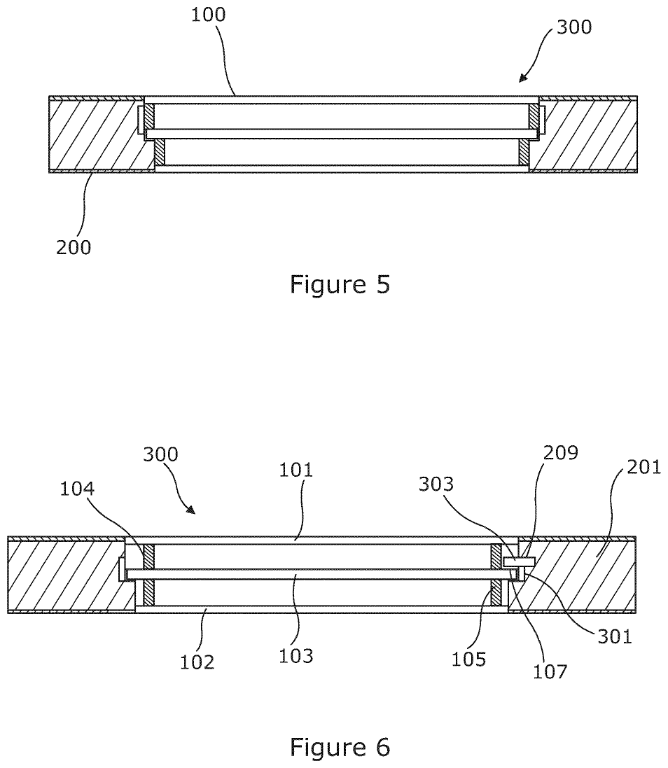

FIG. 5 illustrates a fire door 300 comprising a door leaf 200 and a vision panel assembly 100. In the illustrated example, the vision panel assembly 100 has been inserted into the receiving aperture 204 of the leaf body 201. The first abutment surface 106 of the vision panel assembly 100 substantially in cooperative contact with the second abutment surface 206 of the receiving aperture 204. The cooperative contact between the first abutment surface 106 and the second abutment surface 206 positions the vision panel assembly 100 within the receiving aperture 204.

In the illustrated example, the vision panel assembly 100 is at least partially secured within the receiving aperture 204 by the adhesive 302. The adhesive 302 bonds the vision panel assembly 100 to the receiving aperture 204, thereby to assist with retaining the vision panel assembly 100 within the receiving aperture 204. In the illustrated example, the adhesive 302 bonds at least part of the vision panel 103 to the leaf body 201 of the door leaf 200. In some examples adhesive may additionally, or alternatively, be applied to other portions of the receiving aperture 204 and/or the vision panel assembly 100 in order to at least partially secure the vision panel assembly within the receiving aperture 204.

In the illustrated example, the intumescent strip 301 is at least partially located between the outer perimeter of the vision panel 103 and the groove 207. In such examples, when exposed to elevated temperature (such as in a fire), the intumescent strip 301 will expand and apply a force to the outer perimeter of the vision panel 103. In such examples, if exposed to a fire, the force applied by the expanded intumescent strip helps retain the vision panel 103 within the door leaf 200, thereby preventing the fire from passing through the receiving aperture 204. In combination with the fire resistance of the door leaf 201 and the vision panel 103, this allows for the fire door to provide resistance to a fire.

In some examples, after the vision panel assembly 100 is inserted into the receiving aperture 204 of the door leaf 201 such that the first abutment surface 106 of the vision panel assembly 100 cooperates with the complimentary second abutment surface 206 of the receiving aperture 204, the outer surface of the first window panel 101 is substantially flush with the first side 202 of the leaf body 201. This is advantageous as it may improve the ease with which the first side of the fire door can be cleaned and maintained. This can be particularly advantageous in applications where cleanliness is of particular importance, for example in a hospital environment.

In some examples, after the vision panel assembly 100 is inserted into the receiving aperture 204 of the door leaf 201 such that the first abutment surface 106 of the vision panel assembly 100 cooperates with the complimentary second abutment surface 206 of the receiving aperture 204, the outer surface of the second window panel 102 is substantially flush with the second side 203 of the leaf body 201. This is advantageous as it may improve the ease with which the second side of the fire door can be cleaned and maintained. This can be particularly advantageous in applications where cleanliness is of particular importance, for example in a hospital environment.

In the illustrated example the intumescent strip 301 is at least partially located between the first side 202 of the vision panel 103 and the first side 202 of the leaf body 201. In such examples, when exposed to elevated temperature (such as in a fire), the intumescent strip 301 will expand and provide a physical barrier between the vision panel 103 and the first side 202 of the leaf body 201. In such examples, the vision panel 103 is retained between the stepped formation 205 and the expanded intumescent strip 301. The combination of these two features at least partially helps to retain the vision panel 103 within the door leaf 200, thereby preventing a fire from passing through the receiving aperture 204. In combination with the fire resistance of the door leaf 201 and the vision panel 103, this allows for the fire door to provide resistance to a fire.

FIG. 6 illustrates a further example of a fire door 300 comprising a door leaf 200 and a vision panel assembly 100. In the illustrated example, the first spacer 104 is disposed such that the first window panel 101 and the vision panel 103 each extend past the first spacer 104. In the illustrated example, the leaf body 201 includes a retention formation 209 located within the receiving aperture 204. A retention member 303 is frictionally retained within the retention formation 209. The retention member is located such that it can be abutted by the second abutment surface 107 of the vision panel 103. In the illustrated example, the retention member 303 extends into the space defined by the first spacer 104, the first window panel 101 and the vision panel 103.

In some examples, the intumescent strip 301 may be located so that, in use, it can at least partially expand into a space between the second abutment surface 107 of the vision panel 103 and the retention member 303. Such an arrangement may provide an improved method for retaining the vision panel within the receiving aperture 204 of the leaf body 201, when the fire door is exposed to a fire. This may be particularly beneficial when a fire is exerting an increased pressure on the vision panel 103 from the second side of the fire door 300. This is because the retention member provides an additional abutment surface against which, in use, the intumescent strip 301 can exert force. In such examples, in use, the intumescent strip 301 may simultaneously exert force against the second abutment surface 107 of the vision panel 103 and the retention member 303, thereby helping to retain the vision panel 103 within the receiving aperture 204 of the door leaf 201.

In some examples, in use, the second abutment surface 107 of the vision panel 103 may alternatively (or additionally) directly abut the retention member 303. In such examples, in use, the retention member 303 exerts force directly to the second abutment surface 107 of the vision panel 103, thereby helping to retain the vision panel 103 within the receiving aperture 204 of the door leaf 201.

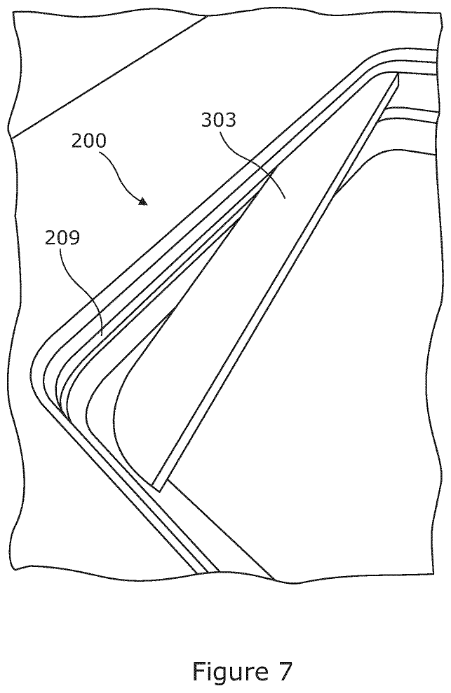

FIG. 7 illustrates an example of a door leaf 200. In the illustrated example, the door leaf 200 includes a retention formation 209. A retention member 303 is being inserted into the retention formation 209, where it is frictionally retained. In some examples, the retention member 303 may be additionally (or alternatively) secured within the retention formation 209 using any suitable method, for example with an adhesive.

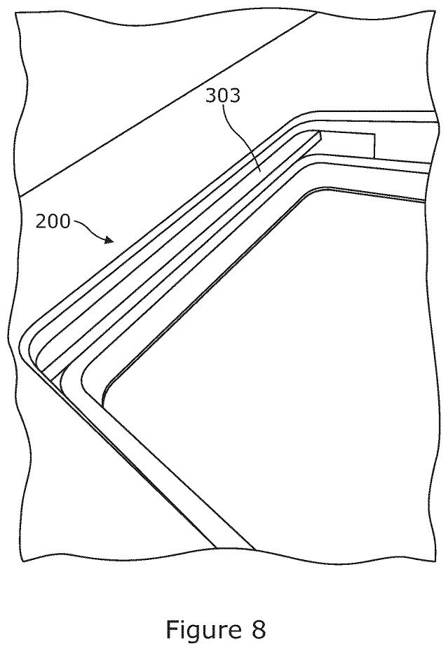

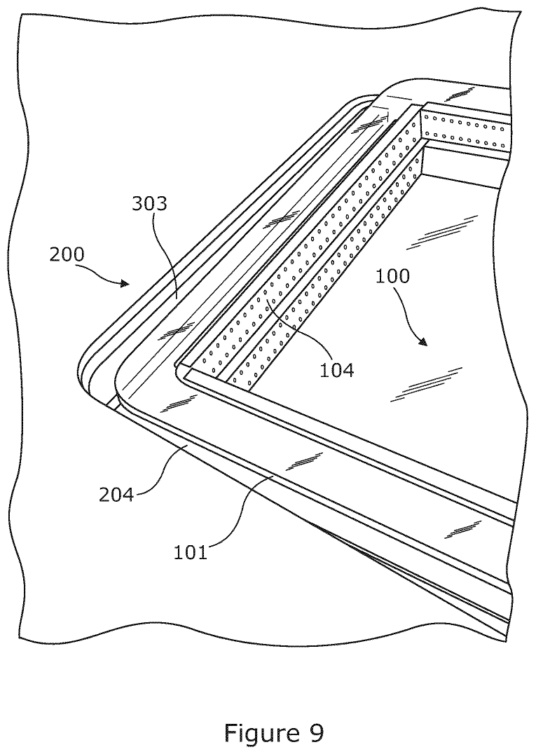

FIG. 8 illustrates the door leaf 200 of FIG. 7, with the retention member 303 fully inserted into the retention formation 209. The retention member 303 protrudes from the side of the aperture, thereby to provide an additional abutment surface against which the vision panel and/or the intumescent strip (not shown) can abut, in use.

FIG. 9 illustrates a method for inserting a vision panel assembly 100 into the receiving aperture 204 of a door leaf 200, wherein the door leaf 200 comprises a retention member 303 that has been inserted into a retention formation (not shown).

In the illustrated example, the vision panel assembly 100 is inserted at an angle such that before the vision panel assembly 100 is fully inserted into the receiving aperture 204, the retention member 303 enters a space defined by the first window panel 101, the vision panel 103 and the first spacer 104 (note that in the illustration, the first spacer is seen by looking through the first window panel 101). Once the retention member 303 is within this space, the vision panel 100 can be fully inserted into the receiving aperture 204.

An example method for assembling a vision panel assembly 100 according to the present invention may comprise the following steps:
Cut a spacer bar into 4 lengths and join them together using corner keys, to make a second spacer frame that is 5 mm less than the width and height of the second window panel.
Apply 3 mm double-sided tape along the 5 mm edge around one side of this second spacer frame.
Place the second window panel on a flat surface, remove the liner paper from the double-sided tape on the second spacer frame and place the frame centrally onto the second window panel, ensuring the edge of the second spacer frame is 5 mm back from the edge of the second window panel.
Apply 3 mm double-sided tape along the 5 mm edge around top side of the second spacer frame.
Remove the liner paper from the double-sided tape and place the fire-rated vision panel centrally onto the second spacer frame, pressing down on the vision panel where it joins the frame to ensure that the vision panel is bonded to the second spacer frame.
Cut a spacer bar into 4 lengths and join them together using plastic corner keys to make a first spacer frame that is 5 mm less than the width and height of the vision panel.
Apply 3 mm double-sided tape along the 5 mm edge around one side of the first spacer frame.
Remove the liner paper from the double-sided tape and place the first spacer frame centrally onto the vision panel ensuring the edge of the first spacer frame is 5 mm back from the edge of the vision panel.
Apply 3 mm double-sided tape along the 5 mm edge around top side of the first spacer frame.
Remove the liner paper from the double-sided tape and place the first window panel centrally onto the first spacer frame, pressing down on the first window panel where it joins the frame to ensure that the first window panel is bonded to it.
Apply fire rated silicone all around the edges of the vision panel ensuring that all pieces of the first and second spacer frames and the edges of the fire-rated vision panel are covered.
Allow the fire rated silicone to cure.
The vision panel assembly is now ready to be installed.

An example method for forming a door leaf 200 according to the present invention may comprise the following steps:
Cut a receiving aperture comprising a stepped portion in the leaf body of the door leaf, with a first opening having a width and height of the first window panel, and a second opening having a width and height of the second window panel, the stepped portion being located between the first and the second openings.
Cut a 3 mm deep×15 mm wide groove in the receiving aperture, 10 mm into the receiving aperture from the first side of the door leaf.

An example method for assembling a fire door 300 according to the present invention may comprise the following steps:
Place an intumescent strip within the groove all around the receiving aperture.
Apply fire rated silicone to the stepped portion of the receiving aperture.
Optionally, insert a retention member into a retention formation.
Insert the vision panel assembly into the receiving aperture, such that the first abutment surface makes contact with the second abutment surface, using the fire rated silicone to secure the vision panel assembly within the receiving aperture. In examples where the door leaf includes a retention member, the vision panel assembly is inserted at an angle such that the retention member enters a space defined by the first window panel, the vision panel and the first spacer, before the vision panel is fully inserted into the receiving aperture.
Allow the fire rated silicone to cure.

1. A door leaf, for use in a fire door, comprising a leaf body having first and second opposed sides and a vision panel assembly receiving aperture extending therethrough, the receiving aperture having a stepped formation defining a second abutment surface co-operable in use with a complementary first abutment surface of a vision panel assembly to position the vision panel assembly within the door leaf.

2. The door leaf according to claim 1, wherein the receiving aperture extends all the way through the leaf body of the door leaf.

3. The door leaf according to claim 1, wherein the stepped formation extends around the whole of the receiving aperture.

4. The door leaf according to claim 1, further comprising at least one retention formation located within the receiving aperture between the stepped formation and the first side of the leaf body.

5. The door leaf according to claim 1, further comprising a groove to, in use, receive an intumescent strip.

6. The door leaf according to claim 5, wherein the groove is located within the receiving aperture between the stepped formation and the first side of the leaf body.

7. The door leaf according to claim 6, including at least one retention formation, wherein the groove is located within the receiving aperture between the retention formation and the stepped formation.

8. A vision panel assembly, for use in a fire door, comprising first and second window panels having a fire-rated vision panel sandwiched therebetween, the first and second window panels being spaced from the vision panel, and the vision panel having a larger cross-sectional area than the second window panel whereby an outer perimeter of the vision panel extends beyond the second window panel to define a first abutment surface co-operable in use with a complementary second abutment surface of a door leaf to position the vision panel assembly within the door leaf.

9. The vision panel assembly according to claim 8, wherein the first window panel is spaced from the vision panel by at least one first spacer.

10. The vision panel assembly according to claim 9, wherein the second window panel is spaced from the vision panel by at least one second spacer.

11. The vision panel assembly according to claim 9, wherein the whole outer perimeter of the vision panel extends beyond the second window panel.

12. The vision panel assembly according to claim 9, , wherein the vision panel defines a second abutment surface arranged opposite to the first abutment surface. 13-23. (canceled)

24. A method of assembling a vision panel assembly for use in a fire door, the vision panel assembly comprising first and second window panels and a fire-rated vision panel with a larger cross-sectional area than the second window panel, the method comprising the steps of:
(a) sandwiching the fire-rated vision panel between first and second window panels while spacing the first and second window panels from the vision panel; and
(b) arranging the vision panel relative to the second window panel so that an outer perimeter of the vision panel extends beyond the second window panel to define a first abutment surface co-operable in use with a complementary second abutment surface of a door leaf to position the vision panel assembly within the door leaf.

25. The method of assembling a vision panel assembly according to claim 24, the method further comprising a step of inserting at least one first spacer between the first window panel and the vision panel.

26. The method of assembling a vision panel assembly according to claim 24, the method further comprising a step of inserting at least one second spacer between the second window panel and the vision panel.

27. A method of forming a door leaf for use in a fire door, the door leaf comprising a leaf body having first and second opposed sides, the method comprising the steps of:
(a) creating a receiving aperture which extends through the door leaf; and
(b) forming within the receiving aperture a stepped formation that defines a second abutment surface co-operable in use with a complementary first abutment surface of a vision panel assembly to position the vision panel assembly within the door leaf.

28. The method of forming a door leaf according to claim 27, further comprising a step of forming a groove within the receiving aperture.

29. The method of forming a door leaf according to claim 27, further comprising a step of forming a retention formation within the receiving aperture.

30. A method of assembling a fire door comprising a door leaf formed according to claim 17 and a vision panel assembly, the method comprising the step of inserting the vision panel assembly into the receiving aperture of the door leaf such that the first abutment surface of the vision panel assembly cooperates with the complimentary second abutment surface of the receiving aperture to position the vision panel assembly with the door leaf.

31. The method of assembling a fire door according to claim 30, the method further comprising a step of inserting into a retention formation a corresponding retention member, prior to the insertion of the vision panel assembly into the receiving aperture of the door leaf.

32. The method of assembling a fire door according to claim 30, the method further comprising a step of applying an adhesive to at least one of the first abutment surface and the second abutment surface, before the vision panel assembly is inserted into the receiving aperture.

33. A fire door comprising a vision panel assembly and a door leaf, wherein:
the vision panel comprises first and second window panels having a fire-rated vision panel sandwiched therebetween, the first and second window panels being spaced from the vision panel, and the vision panel having a larger cross-sectional area than the second window panel whereby an outer perimeter of the vision panel extends beyond the second window panel to define a first abutment surface co-operable in use with a complementary second abutment surface of a door leaf to position the vision panel assembly within the door leaf;
the door leaf comprises a leaf body having first and second opposed sides and a vision panel assembly receiving aperture extending therethrough, the receiving aperture having a stepped formation defining a second abutment surface co-operable in use with a complementary first abutment surface of a vision panel assembly to position the vision panel assembly within the door leaf; and
the vision panel assembly being received within the receiving aperture of the door leaf and the first abutment surface of the vision panel assembly cooperating with the complementary second abutment surface of the door leaf to position the vision panel assembly within the door leaf.

34. The fire door according to claim 33, wherein the vision panel is located on the first side of the stepped formation.

35. The fire door according to claim 33, further comprising an intumescent strip located within the groove.

36. The fire door according to claim 35, wherein the intumescent strip is at least partially located between the vision panel and the groove.

37. The fire door according to claim 35, wherein the intumescent strip is located at least partially on the side of the vision panel opposite to the first abutment surface.

38. The fire door according to claim 33, further comprising an adhesive located between the first and second abutment surfaces, preferably fire rated silicone.

39. The fire door according to claim 33, wherein the outer surface of the first window panel is substantially flush with the first side of the leaf body.

40. The fire door according to claim 33, wherein the outer surface of the second window panel is substantially flush with the second side of the leaf body.

41. The fire door according to claim 33, including at least one retention formation, the, or each, retention formation frictionally retaining a corresponding retention member against which the second abutment surface of the vision panel is abuttable.

42. The fire door according to claim 41, including an intumescent strip, wherein, in use, the intumescent strip is expandable between at least one retention member and the vision panel.

43. The fire door according to claim 41, wherein the, or each, retention member comprises a fire-resistant material, preferably calcium silicate.
